(19) United States
(12) Patent Application Publication
(10) Pub. No.: US 2010/0257347 A1
(43) Pub. Date: Oct. 7, 2010

(54) NETWORK DEVICE AND AN IMAGE UPDATE METHOD THEREOF

(75) Inventor: WEN-YUAN WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/713,298

(22) Filed: Feb. 26, 2010

(30) Foreign Application Priority Data
Apr. 1, 2009 (CN) 200910301278.1

(51) Int. Cl. G06F 3/00; G06F 15/16; G06F 9/00

(52) U.S. Cl. 713/2; 709/219; 710/52

(57) ABSTRACT

A network device and an image update method include a control card and a daughterboard embedded in the control card. The control card includes a download module to download an integrated image from a trivial file transfer protocol (TFTP) server, a first retrieving module to retrieve a control card image from the integrated image, and a first storage module to store the control card image. The daughterboard includes a second retrieving module to retrieve a daughterboard image from the integrated image, and a second storage module to store the daughterboard image.

### BACKGROUND

1. Technical Field

The present disclosure relates to network devices, and particularly to a network device and an image update method thereof.

2. Description of Related Art

Network systems, such as public switched telephone network (PSTN) systems or voice over Internet protocol (VoIP) network systems, utilize a plurality of gateways to transmit voice signals and/or data packages. Frequently, a gateway includes a control card and a daughterboard embedded in the control card, and images of the control card and images of the daughterboard are downloaded from a trivial file transfer protocol (TFTP) server and are updated separately. However, in this process, much time is spent on updating the images of the control card and the images of the daughterboard, causing possible mismatching of the images of the control card and the images of the daughterboard.

Therefore, a need exists in the industry to overcome the described limitations.

### BRIEF DESCRIPTION OF THE DRAWINGS

FIG. 1 is a diagram of an application environment of a network device of one embodiment of the present disclosure.

FIG. 2 is a schematic diagram of one embodiment of the network device of FIG. 1.

FIG. 3 is a format diagram of one embodiment of an integrated image downloaded by the network device of FIG. 1.

FIG. 4 is a block diagram of one embodiment of a control card and a daughterboard of the network device of FIG. 1.

FIG. 5 is a flowchart of one embodiment of an image update method for a network device, such as, for example, that of FIG. 1 according to the present disclosure.

### DETAILED DESCRIPTION

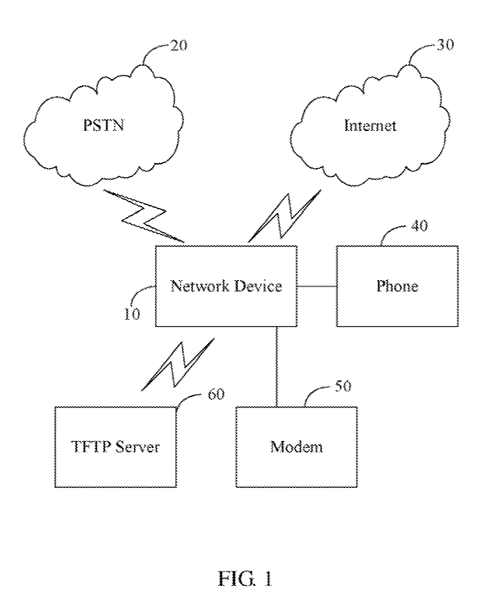

FIG. 1 is a diagram of an application environment of a network device 10 of one embodiment of the present disclosure. A public switched telephone network (PSTN) 20, the Internet 30, a phone 40, a modem 50, and a trivial file transfer protocol (TFTP) server 60 are connected to the network device 10. The network device 10 transmits voice signals among the phone 40, the Internet 30, and the PSTN 20, and voice signals and data packages among the modem 50, the TFTP server 60, and the Internet 30. The Internet 30 may be an Intranet, a Fiber Channel network, Storage Area Network (SAN), Local Area Network (LAN), for example. In one embodiment, the network device 10 may be a gateway.

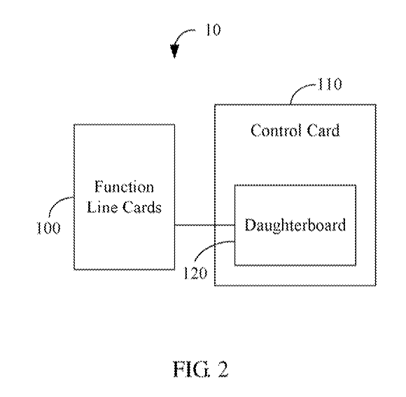

FIG. 2 is a schematic diagram of one embodiment of the network device 10. In one embodiment, the network device 10 includes a control card 110, a daughterboard 120 embedded in the control card 110, and a plurality of function line cards 100, for example, voice over Internet protocol (VoIP) line cards, asymmetrical digital subscriber loop (ADSL) line cards, for example. The control card 110 serves as the command and control center of the network device 10, and downloads an integrated image from the TFTP server 60. In one embodiment, the integrated image is a matched image for the control card 110 and the daughterboard 120. The daughterboard 120 redirects voice signals and/or data packages to the plurality of function line cards 100. The plurality of function line cards 100 processes voice signals and/or data packages from the daughterboard 120 and transmits the processed voice signals and/or data packages to the phone 40 and the PSTN 20 and/or the modem 50 and the Internet 30.

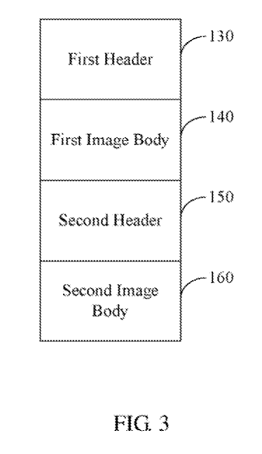

FIG. 3 is a format diagram of one embodiment of the integrated image downloaded by the network device 10. The integrated image includes a first header 130, a first image body 140, a second header 150, and a second image body 160. In one embodiment, the first header 130 and the second image body 140 are the header and the image body of the control card 110, respectively. The second header 150 and the second image body 160 are the header and the image body of the daughterboard 120, respectively. In one embodiment, each of the first and second headers 130, 150 include an image version, an image type, a checksum, and a file size.

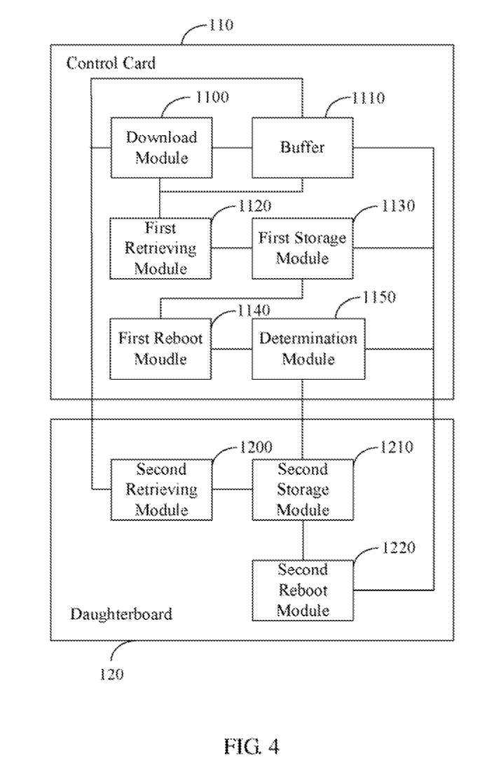

FIG. 4 is a block diagram of one embodiment of the control card 110 and the daughterboard 120 of the network device 10. In one embodiment, the control card 110 includes a download module 1100 to download the integrated image from the TFTP server 60, a first retrieving module 1120, and a first storage module 1130. The first retrieving module 1120 retrieves a control card image including the first header 130 and the first image body 140 from the integrated image, and stores the control card image to the first storage module 1130. In one embodiment, the first storage module 1130 may be local flash storage.

The daughterboard 120 includes a second retrieving module 1200 and a second storage module 1210. The second retrieving module 1200 retrieves a daughterboard image including the second header 150 and the second image body 160 from the integrated image, and stores the daughterboard image to the second storage module 1210. In one embodiment, the second storage module 1210 may be local flash memory storage.

In one embodiment, the control card 110 further includes a buffer 1110 to temporarily store the integrated image from the download module 1100. In one embodiment, the first retrieving module 1120 retrieves the control card image and the second retrieving module 1200 retrieves the daughterboard image from the download module 1100. Alternatively, the first retrieving module 1120 can retrieve the control card image and the second retrieving module 1200 can retrieve the daughterboard image from the buffer 1110.

In one embodiment, the control card 110 further includes a first reboot module 1140 and a determination module 1150. The daughterboard 120 further includes a second reboot module 1220. The first reboot module 1140 restarts the control card 110 after the first storage module 1130 receives a new control card image, namely the control card 110 is restarted to run the new control card image. The second reboot module 1220 restarts the daughterboard 120 after the second storage module 1210 receives a new daughterboard image, namely the daughterboard 120 is restarted to run the new daughterboard image.

The determination module 1150 determines whether the control card image matches the daughterboard image when the control card 110 and the daughterboard 120 are restarted. If the control card image does not match the daughterboard image when the control card 110 and the daughterboard 120 are restarted, the determination module 1150 retrieves a new daughterboard image from the buffer 1110 and stores the new daughterboard image to the second storage module 1210, updating the daughterboard image to match the control card image. In one embodiment, the determination module 1150 retrieves the image version of the daughterboard image from the second storage module 1210 and the image version of the control card image from the first storage module 1130, and determines whether the control card image matches the daughterboard image in light of the image version of the daughterboard image and the image version of the control card image. If the image version of the daughterboard image is the same as the control card image, the daughterboard image matches the control card image. Otherwise, the daughterboard image and control card image do not match.

The daughterboard image and the control card image are merged into one integrated image and downloaded from the TFTP server 60 at the same time, reducing update time for the control card 110 and daughterboard 120 and reducing possible mismatching of the daughterboard image and the control card image. In addition, when the control card 110 and daughterboard 120 are restarted, the control card 110 automatically compares the control card image with the daughterboard image, further reducing possible mismatching of the daughterboard image and the control card image and securing normal operation of the network device 10.

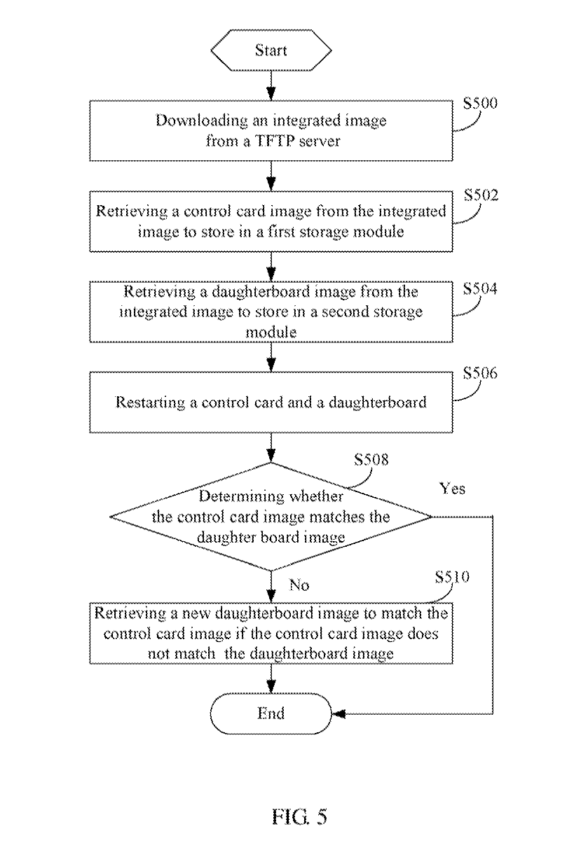

FIG. 5 is a flowchart of an image update method for the network device 10, such as, for example, that of FIG. 1. In step 500, the download module 1100 of the control card 110 downloads the integrated image from the TFTP server 60 and stores the integrated image to the buffer 1110.

In step 502, the first retrieving module 1120 of the control card 110 retrieves the control card image from the integrated image and stores the control card image to the first storage module 1130.

In step 504, the second retrieving module 1200 of the daughterboard 120 retrieves the daughterboard image from the integrated image and stores the daughterboard image to the second storage module 1210. In one embodiment, step 502 and step 504 do not have to be in sequence. The second retrieving module 1200 retrieves the daughterboard image and the first retrieving module 1120 retrieves the control card image from the buffer 1110 or the download module 1100.

In step 506, the first reboot 1140 restarts the control card 110, and the second reboot module 1220 restarts the daughterboard 120.

In step 508, the determination module 1150 determines whether the control card image matches the daughterboard image. In one embodiment, the determination module 1150 retrieves the image version of the daughterboard image from the second storage module 1210 and the image version of the control card image from the first storage module 1130, and determines whether the control card image matches the daughterboard image in light of the image version of the daughterboard image and the image version of the control card image. If the image version of the daughterboard image is the same as the control card image, namely the daughterboard image matches the control card image, the process is ended.

In step 510, if the daughterboard image does not match the control card image, the determination module 1150 retrieves a new daughterboard image from the buffer 1110 and stores the new daughterboard image to the second storage module 1210, updating the daughterboard image to match the control card image.

While embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A network device, comprising:
a control card comprising a download module to download an integrated image from a trivial file transfer protocol (TFTP) server, a first retrieving module to retrieve a control card image from the integrated image, and a first storage module to store the control card image; and
a daughterboard embedded in the control card, comprising a second retrieving module to retrieve a daughterboard image from the integrated image, and a second storage module to store the daughterboard image.

2. The network device as recited in claim 1, wherein the control card further comprises a buffer to temporarily store the integrated image from the download module.

3. The network device as recited in claim 2, wherein the control card further comprises a first reboot module to restart the control card after the first storage module receives a new control card image.

4. The network device as recited in claim 3, wherein the daughterboard further comprises a second reboot module to restart the daughterboard after the second storage module receives a new daughterboard image.

5. The network device as recited in claim 4, wherein the control card further comprises a determination module to determine whether the control card image matches the daughterboard image when the control card and the daughterboard are restarted.

6. The network device as recited in claim 5, wherein the determination module retrieves a new daughterboard image from the buffer if the control card image does not match the daughterboard image.

7. The network device as recited in claim 6, wherein the control card image comprises a first header and image body, and the comprises a second header and image body, wherein the first and second headers comprise an image version, respectively.

8. The network device as recited in claim 7, wherein the determination module determines whether the control card image matches the daughterboard image in light of the image version of the daughterboard image and the image version of the control card image.

9. An image update method of a network device comprising a control card comprising a first storage module and a daughterboard embedded in the control card and comprising a second storage module, the method comprising:
downloading an integrated image from a trivial file transfer protocol (TFTP) server;
retrieving a control card image from the integrated image to store in the first storage module;
retrieving a daughterboard image from the integrated image to store in the second storage module; and
restarting the control card and the daughterboard.

10. The image update method as claimed in claim 9, further comprising determining whether the control card image matches the daughterboard image.

11. The image update method as claimed in claim 10, further comprising retrieving a new daughterboard image to match the control card image if the control card image does not match the daughterboard image.

12. The image update method as claimed in claim 11, wherein the control card image comprises a first header and image body, and the daughterboard image comprises a second header and image body, wherein the first and second headers comprise an image version, respectively.

13. The image update method as claimed in claim 12, wherein if the image version of the daughterboard image is the same as the control card image, the daughterboard image matches the control card image.
